(19) United States
(12) Patent Application Publication
(10) Pub. No.: US 2012/0270965 A1
(43) Pub. Date: Oct. 25, 2012

(54) Thermoplastic Resin Composition and Molded Product Using Same

(75) Inventors: In-Chol KIM, Uiwang-si (KR); Doo-Han HA, Uiwang-si (KR); Tae-Woog JANG, Uiwang-si (KR); Dong-Hui CHU, Uiwang-si (KR)

(73) Assignee: CHEIL INDUSTRIES INC., Gumi-si (KR)

(21) Appl. No.: 13/535,970

(22) Filed: Jun. 28, 2012

Related U.S. Application Data
(63) Continuation-in-part of application No. PCT/KR2010/008807, filed on Dec. 9, 2010.

(30) Foreign Application Priority Data
Dec. 31, 2009 (KR) 10-2009-0136188

(51) Int. Cl. C08L 55/02; C08K 5/20; C08L 51/04

(52) U.S. Cl. 523/122; 524/230

(57) ABSTRACT

Provided are a thermoplastic resin composition including (A) a core-shell structured copolymer including a shell polymerized from at least an acrylic-based compound, (B) an acrylic-based polymer polymerized from at least an acryl-based monomer, and (C) a surface-controlling agent, and a molded product using the same.

### CROSS-REFERENCE TO RELATED APPLICATIONS

This application is a continuation-in-part of International Application No. PCT/KR2010/008807, filed Dec. 9, 2010, pending, which designates the U.S., published as WO 2011/081317, and is incorporated herein by reference in its entirety, and claims priority therefrom under 35 USC Section 120. This application also claims priority under 35 USC Section 119 from Korean Patent Application No. 10-2009-0136188, filed Dec. 31, 2009, the entire disclosure of which is also incorporated herein by reference.

### FIELD

This disclosure relates to a thermoplastic resin composition and a molded product using the same.

### BACKGROUND

An acrylonitrile-butadiene-styrene (ABS) resin having excellent impact resistance, heat resistance, and workability is widely used for interior and exterior materials of electronic products and office electronic devices. As the interest in the aspects of appearances increases as much as the functional aspects, general ABS resins which provide relatively inferior color quality and scratch resistance are not suitable for use in high-quality interior/exterior materials.

Although urethane coatings, UV coatings, and acrylic resin coatings can be applied to the surface of a resin in order to improve the scratch characteristics of the general ABS resin, such post-processing steps have drawbacks, such as increased processing costs, high defect rates, and deteriorating productivity. Therefore, there is a need for a resin having excellent scratch resistance.

### SUMMARY

One embodiment provides a thermoplastic resin composition that can have excellent scratch resistance, surface slip properties, abrasion resistance, high gloss, impact resistance, heat resistance, workability, coloring properties, and the like.

Another embodiment provides a molded product manufactured using the thermoplastic resin composition.

One embodiment provides a thermoplastic resin composition that includes (A) about 10 to about 40 wt % of a core-shell structured copolymer including a shell polymerized from at least an acrylic-based compound; (B) about 60 to about 90 wt % of an acrylic-based polymer polymerized from at least an acrylic-based monomer; and (C) about 0.1 to about 5 parts by weight of a surface-controlling agent based on 100 parts by weight of the (A) and (B) components.

The shell may be polymerized from the acrylic-based compound and a copolymer of an aromatic vinyl compound and a vinyl cyanide compound, and the shell may be polymerized from about 50 to about 80 wt % of the acrylic-based compound and about 20 to about 50 wt % of the copolymer of an aromatic vinyl compound and a vinyl cyanide compound. The core-shell structured copolymer (A) may include a copolymer in which the acrylic-based compound and a copolymer of an aromatic vinyl compound and a vinyl cyanide compound are grafted on a polybutadiene rubber.

The acrylic-based polymer (B) may be polymerized from the acrylic-based monomer in an amount of 40 wt % or more, based on the total amount (weight) of the acrylic-based polymer. Examples of the acrylic-based polymer (B) may include without limitation polyalkyl(meth)acrylate; a copolymer of an acrylic-based monomer and an aromatic vinyl monomer; a copolymer of an acrylic-based monomer, an aromatic vinyl monomer, and a vinyl cyanide monomer; and the like, and combinations thereof.

The surface-controlling agent (C) may include a fatty acid amide compound. Examples of the fatty acid amide compound may include without limitation stearamide, erucamide, oleamide, behenamide, and the like, and combinations thereof.

The thermoplastic resin composition may further include one or more additive. Examples of the additives include without limitation antibacterial agents, heat stabilizers, antioxidants, release agents, light stabilizers, surfactants, coupling agents, plasticizers, admixtures, colorants, stabilizers, lubricants, antistatic agents, coloring aids, flameproofing agents, weather-resistance agents, ultraviolet (UV) absorbers, ultraviolet (UV) blocking agents, nucleating agents, adhesion aids, adhesives, and the like, and combinations thereof.

According to another embodiment, a molded product fabricated using the thermoplastic resin composition is provided.

The thermoplastic resin composition can have excellent scratch resistance, surface slip properties, abrasion resistance, high gloss, impact resistance, heat resistance, workability, coloring properties, and the like, and thus may be used in the production of various electronic parts, automobile parts, miscellaneous parts, and the like.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

When a specific definition is not otherwise provided, the term “(meth)acrylate” refers to “acrylate” and “methacrylate”. “(Meth)acrylic acid alkyl ester” refers to both “acrylic acid alkyl ester” and “methacrylic acid alkyl ester”, and “(meth)acrylic acid ester” refers to both “acrylic acid ester” and “methacrylic acid ester”.

When a specific definition is not otherwise provided, the term “heterocyclic compound” may refer to a cyclic compound including a heteroatom including N, O, S, P, or a combination thereof.

A thermoplastic resin composition according to one embodiment includes (A) a core-shell structured copolymer including a shell polymerized from at least an acrylic-based compound, (B) an acrylic-based polymer polymerized from at least an acrylic-based monomer, and (C) a surface-controlling agent.

Each component included in the thermoplastic resin composition according to embodiments will hereinafter be described in detail.

(A) Core-Shell Structured Copolymer

The core-shell structured copolymer is a copolymer having a core-shell structure where unsaturated compounds are grafted on a rubber core to form a hard shell.

Examples of the rubber may include without limitation polybutadiene rubbers, acrylic rubbers, ethylene/propylene rubbers, butadiene/styrene rubbers, acrylonitrile/butadiene rubbers, isoprene rubbers, terpolymers of ethylene-propylene-diene, and the like, and combinations thereof. In exemplary embodiments, a polybutadiene rubber or a butadiene/styrene rubber may be used.

The rubber may have an average particle diameter of about 0.05 to about 4 μm. When the average particle diameter is within the above range, impact resistance and surface characteristics of the molded products may be improved.

The core-shell structured copolymer may include the rubber in an amount of about 30 to about 70 wt % based on the total amount (weight) of the core-shell structured copolymer. In some embodiments, the core-shell structured copolymer may include the rubber in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the rubber can be in a range from about any of the foregoing amounts to about any other of the foregoing amounts.

When the rubber is included in an amount within the above range, excellent impact resistance and high gloss of molded products may be obtained.

The unsaturated compound polymerized to form the shell may include an acrylic-based compound. The acrylic-based compound may be an acrylic-based monomer or a polymer thereof. Examples of the acrylic-based monomer may include without limitation (meth)acrylic acid alkyl esters, (meth)acrylic acid esters, and the like, and combinations thereof. As used herein, the alkyl may be a C1 to C10 alkyl. Examples of the (meth)acrylic acid alkyl ester may include without limitation methyl(meth)acrylate, ethyl(meth)acrylate, propyl(meth)acrylate, butyl(meth)acrylate, and the like, and combinations thereof. In exemplary embodiments, methyl(meth)acrylate may be used. Examples of the (meth)acrylic acid ester may be (meth)acrylate, and the like. The polymer of the acrylic-based monomer may include polymethylmethacrylate, and the like.

The unsaturated compound may further include an aromatic vinyl compound, a vinyl cyanide compound, a heterocyclic compound, a copolymer thereof, or a combination thereof, along with the acrylic-based compound. In exemplary embodiments, the unsaturated compound may further include a copolymer of an aromatic vinyl compound and a vinyl cyanide compound.

Examples of the aromatic vinyl compound may include without limitation styrene, C1 to C10 alkyl-substituted styrene, halogen-substituted styrene, and the like, and combinations thereof. Examples of the alkyl-substituted styrene may include without limitation o-ethyl styrene, m-ethyl styrene, p-ethyl styrene, α-methyl styrene, and the like, and combinations thereof.

Examples of the vinyl cyanide compound may include without limitation acrylonitrile, methacrylonitrile, ethacrylonitrile, and the like, and combinations thereof.

Examples of the heterocyclic compound may include without limitation maleic anhydride, C1-C10 alkyl or phenyl N-substituted maleimides, and the like, and combinations thereof.

When the shell is polymerized from the acrylic-based compound and the copolymer of an aromatic vinyl compound and a vinyl cyanide compound, about 50 to about 80 wt % of the acrylic-based compound and about 20 to about 50 wt % of the copolymer of an aromatic vinyl compound and a vinyl cyanide compound may be polymerized.

In some embodiments, the shell may include the acrylic-based compound polymerized in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the acrylic-based compound can be in a range from about any of the foregoing amounts to about any other of the foregoing amounts.

In some embodiments, the shell may include the copolymer of an aromatic vinyl compound and a vinyl cyanide compound polymerized in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the copolymer of an aromatic vinyl compound and a vinyl cyanide compound can be in a range from about any of the foregoing amounts to about any other of the foregoing amounts.

When the acrylic-based compound and the copolymer of an aromatic vinyl compound and a vinyl cyanide compound are polymerized in an amount within the about ratio range, polymerization stability can be high.

The shell structure may be a single shell structure, or a double shell structure having an inner shell which can provide impact resistance and an outer shell which can provide transparency and scratch resistance.

In the case of the double shell structure, the inner shell and the outer shell may be independently polymerized from an acrylic-based compound, an aromatic vinyl compound, a vinyl cyanide compound, a heterocyclic compound, a copolymer thereof, or a combination thereof. According to one embodiment, the inner shell may be polymerized from a copolymer of an aromatic vinyl compound and a vinyl cyanide compound, and the outer shell may be polymerized from an acrylic-based compound. The double shell structure may have high polymerization stability during polymerization and can provide excellent impact resistance by contributing to dispersion of rubber in an acrylic-based compound.

The unsaturated compound polymerized to form the shell may be used in an amount of about 30 to about 70 wt % based on the total amount (weight) of the core-shell structured copolymer. In some embodiments, the unsaturated compound polymerized to form the shell may be used in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the unsaturated compound polymerized to form the shell can be in a range from about any of the foregoing amounts to about any other of the foregoing amounts.

When the unsaturated compound is included in an amount within the above range, it can be advantageous for dispersion.

The core-shell structured copolymer may include a copolymer in which the acrylic-based compound and the copolymer of an aromatic vinyl compound and a vinyl cyanide compound are grafted on the polybutadiene rubber. In this case, core-shell structured copolymer can include about 30 to about 70 wt % of the polybutadiene rubber, about 15 to about 55 wt % of the acrylic-based compound, about 5 to about 35 wt % of the aromatic vinyl compound, and about 1 to about 5 wt % of the vinyl cyanide compound.

In some embodiments, the core-shell structured copolymer can include the polybutadiene rubber in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the polybutadiene rubber can be in a range from about any of the foregoing amounts to about any other of the foregoing amounts.

In some embodiments, the core-shell structured copolymer can include the acrylic-based compound in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt %. Further, according to some embodiments of the present invention, the amount of the acrylic-based compound can be in a range from about any of the foregoing amounts to about any other of the foregoing amounts.

In some embodiments, the core-shell structured copolymer can include the aromatic vinyl compound in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 wt %. Further, according to some embodiments of the present invention, the amount of the aromatic vinyl compound can be in a range from about any of the foregoing amounts to about any other of the foregoing amounts.

In some embodiments, the core-shell structured copolymer can include the vinyl cyanide compound in an amount of about 1, 2, 3, 4, or 5 wt %. Further, according to some embodiments of the present invention, the amount of the vinyl cyanide compound can be in a range from about any of the foregoing amounts to about any other of the foregoing amounts.

When the core-shell structured copolymer includes the polybutadiene rubber, the acrylic-based compound, the aromatic vinyl compound, and the vinyl cyanide compound in amounts within the above ranges, the rubber may be well dispersed in a matrix, high impact resistance can be provided, and polymerization stability can be excellent, which enables high yield production.

The copolymer in which acrylic-based compound and the copolymer of an aromatic vinyl compound and a vinyl cyanide compound are grafted on the polybutadiene rubber may include methylmethacrylate-acrylonitrile-butadiene-styrene (MABS), and the like.

The thermoplastic resin composition may include the core-shell structured copolymer in an amount of about 10 to about 40 wt %, for example about 15 to about 30 wt % based on the total amount (weight) of the core-shell structured copolymer (A) and the acrylic-based polymer (B). In some embodiments, the thermoplastic resin composition may include the core-shell structured copolymer in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of the core-shell structured copolymer can be in a range from about any of the foregoing amounts to about any other of the foregoing amounts.

When the core-shell structured copolymer is included in an amount within the above range, impact resistance, hardness, and scratch resistance may be excellent.

(B) Acrylic-Based Polymer

The acrylic-based polymer is a linear polymer polymerized from at least an acrylic-based monomer. As used herein, the acrylic-based polymer may be polymerized from the acrylic-based monomer in an amount of about 40 wt % or more, for example about 50 to about 100 wt %, based on the total amount of the acrylic-based polymer. In some embodiments, the acrylic-based polymer may be polymerized from the acrylic-based monomer in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt %. Further, according to some embodiments of the present invention, the amount of the acrylic-based monomer can be in a range from about any of the foregoing amounts to about any other of the foregoing amounts.

When the acrylic-based monomer is included in an amount within the above range, scratch resistance can be excellent.

Examples of the acrylic-based monomer may include without limitation (meth)acrylic acid alkyl esters, (meth)acrylic acid esters, and the like, and combinations thereof. As used herein, the alkyl may be a C1 to C10 alkyl. Examples of the (meth)acrylic acid alkyl ester may include without limitation methyl(meth)acrylate, ethyl(meth)acrylate, propyl(meth)acrylate, butyl(meth)acrylate, and the like, and combinations thereof. In exemplary embodiments, methyl(meth)acrylate may be used. Examples of the (meth)acrylic acid ester may include without limitation (meth)acrylate, and the like.

Examples of the acrylic-based polymer may include without limitation polyalkyl(meth)acrylate; a copolymer of an acrylic-based monomer and an aromatic vinyl monomer; a copolymer of an acrylic-based monomer, an aromatic vinyl monomer, and a vinyl cyanide monomer; and the like, and combinations thereof.

The polyalkyl(meth)acrylate can be resistant to hydrolysis and may improve scratch resistance of a thermoplastic resin composition.

The polyalkyl(meth)acrylate resin may be obtained by polymerizing a monomer material including the acrylic-based monomer through a known polymerization process such as a suspension polymerization process, a mass (bulk) polymerization process, an emulsion polymerization process and the like.

The monomer material may further include a vinyl-based monomer other than the acrylic-based monomer. Examples of the vinyl-based monomer may include without limitation aromatic vinyl monomers such as styrene, α-methylstyrene, p-methylstyrene, and the like; vinyl cyanide monomers such as acrylonitrile, methacrylonitrile, and the like; and the like, and combinations thereof.

The polyalkyl(meth)acrylate resin may include polymethylmethacrylate, and the like.

The polyalkyl(meth)acrylate resin may have a weight average molecular weight of about 10,000 to about 200,000 g/mol, for example about 15,000 to about 150,000 g/mol. When the polyalkyl(meth)acrylate has a weight average molecular weight within the above range, it can have good compatibility with the core-shell structured copolymer and thus hydrolysis resistance, scratch resistance, workability, and the like can be excellent.

Examples of the aromatic vinyl monomer may include without limitation styrene, C1 to C10 alkyl-substituted styrene, halogen-substituted styrene, and the like, and combinations thereof. Examples of the alkyl-substituted styrene may include without limitation o-ethyl styrene, m-ethyl styrene, p-ethyl styrene, α-methyl styrene, and the like, and combinations thereof.

Examples of the vinyl cyanide compound may include without limitation acrylonitrile, methacrylonitrile, ethacrylonitrile, and the like, and combinations thereof.

The copolymer of an acrylic-based monomer and an aromatic vinyl monomer may include about 40 to about 99.9 wt % of the acrylic-based monomer and about 0.1 to about 60 wt % of the aromatic vinyl monomer.

In some embodiments, the copolymer of an acrylic-based monomer and an aromatic vinyl monomer may include an acrylic-based monomer in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or 99.9 wt %. Further, according to some embodiments of the present invention, the amount of the acrylic-based monomer can be in a range from about any of the foregoing amounts to about any other of the foregoing amounts.

In some embodiments, the copolymer may include an aromatic vinyl monomer in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %. Further, according to some embodiments of the present invention, the amount of the aromatic vinyl monomer can be in a range from about any of the foregoing amounts to about any other of the foregoing amounts.

When the copolymer includes an acrylic-based monomer and an aromatic vinyl monomer in amounts within the above ratio range, scratch resistance and polymerization stability may be excellent.

The copolymer of an acrylic-based monomer and an aromatic vinyl monomer may include a methyl methacrylate-styrene copolymer, and the like.

The copolymer of an acrylic-based monomer, an aromatic vinyl monomer, and a vinyl cyanide monomer may include about 40 to about 99.8 wt % of the acrylic-based monomer, about 0.1 to about 40 wt % of the aromatic vinyl monomer, and about 0.1 to about 20 wt % of the vinyl cyanide monomer.

In some embodiments, the copolymer of an acrylic-based monomer, an aromatic vinyl monomer, and a vinyl cyanide monomer may include an acrylic-based monomer in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, or 99.8, wt %. Further, according to some embodiments of the present invention, the amount of the acrylic-based monomer can be in a range from about any of the foregoing amounts to about any other of the foregoing amounts.

In some embodiments, the copolymer of an acrylic-based monomer, an aromatic vinyl monomer, and a vinyl cyanide monomer may include an aromatic vinyl monomer in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the amount of the aromatic vinyl monomer can be in a range from about any of the foregoing amounts to about any other of the foregoing amounts.

In some embodiments, the copolymer of an acrylic-based monomer, an aromatic vinyl monomer, and a vinyl cyanide monomer may include an vinyl cyanide monomer in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 wt %. Further, according to some embodiments of the present invention, the amount of the vinyl cyanide monomer can be in a range from about any of the foregoing amounts to about any other of the foregoing amounts.

When the copolymer includes an acrylic-based monomer, an aromatic vinyl monomer and a vinyl cyanide monomer in amounts within the above ratio range, polymerization stability and high gloss scratch resistance can be excellent.

The copolymer of an acrylic-based monomer, an aromatic vinyl monomer, and a vinyl cyanide monomer may include a methylmethacrylate-styrene-acrylonitrile copolymer, and the like.

The acrylic-based polymer may have a weight average molecular weight of about 70,000 to about 120,000 g/mol. When the acrylic-based polymer has a weight average molecular weight within the above range, appropriate fluidity may be obtained and impact resistance can be excellent.

The thermoplastic resin composition may include the acrylic-based polymer in an amount of about 60 to about 90 wt %, for example about 75 to about 87 wt %, based on the total amount (weight) of the core-shell structured copolymer (A) and the acrylic-based polymer (B). In some embodiments, the thermoplastic resin composition may include the acrylic-based polymer in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the acrylic-based polymer can be in a range from about any of the foregoing amounts to about any other of the foregoing amounts.

When the acrylic-based polymer is included in an amount within the above range, scratch resistance can be excellent.

(C) Surface-Controlling Agent

The surface-controlling agent gives a thermoplastic resin surface slip properties, and a fatty acid amide compound may be used as the surface-controlling agent.

The fatty acid amide compound includes an hydrophobic C12 to C24 alkyl group other than an amide group in its compound structure, and it may also include less than or equal to 3 double bonds.

Examples of a surface-controlling agent may include without limitation stearamide, erucamide, oleamide, behenamide, and the like, and combinations thereof.

The thermoplastic resin composition may include the surface-controlling agent in an amount of about 0.1 to about 5 parts by weight, for example about 0.5 to about 3 parts by weight, and as another example about 0.5 to about 2 parts by weight based on about 100 parts by weight of the core-shell structured copolymer (A) and the acrylic-based polymer (B). In some embodiments, the thermoplastic resin composition may include the surface-controlling agent in an amount of about 0.1, 0.2, 0.3, 0.4, 0.5, 0.6, 0.7, 0.8, 0.9, 1, 2, 3, 4, or 5 parts by weight. Further, according to some embodiments of the present invention, the amount of the surface-controlling agent can be in a range from about any of the foregoing amounts to about any other of the foregoing amounts.

When the surface-controlling agent is included in an amount within the above range, excellent surface slip properties and excellent formability may be obtained.

(D) Other Additive(s)

The thermoplastic resin composition according to one embodiment can include one or more additives. Examples of the additives include without limitation antibacterial agents, heat stabilizers, antioxidants, release agents, light stabilizers, surfactants, coupling agents, plasticizers, admixtures, colorants, stabilizers, lubricants, antistatic agents, coloring aids, flameproofing agents, a weather-resistance agents, ultraviolet (UV) absorbers, ultraviolet (UV) blocking agents, nucleating agents, adhesion aids, adhesives, and the like, and combinations thereof.

Examples of the antioxidant may include without limitation phenol antioxidants, phosphite antioxidants, thioether antioxidants, amine antioxidants, and the like, and combinations thereof. Examples of the release agent may include without limitation fluorine-included polymers, silicon oils, stearic metal salts, montanic metal salts, montanic ester waxes, polyethylene waxes, and the like, and combinations thereof. Examples of the weather-resistance agent may include without limitation benzophenone-type weather-resistance agents, amine-type weather-resistance agents, and the like, and combinations thereof. Examples of the colorant may include without limitation dyes, pigments, and the like, and combinations thereof. Examples of the ultraviolet (UV) ray blocking agent may include without limitation titanium oxide (TiO₂), carbon black, and the like, and combinations thereof. Examples of the nucleating agent may include without limitation talc, clay, and the like, and combinations thereof.

The additive may be included in a predetermined amount as long as it does not deteriorate the properties of the thermoplastic resin composition. In exemplary embodiments, the thermoplastic resin composition may include the additive in an amount of less than or equal to about 40 parts by weight, for example about 0.1 to about 30 parts by weight based on about 100 parts by weight of the thermoplastic resin composition.

The thermoplastic resin composition may be prepared using any well-known method of preparing a resin composition. For example, each component according to one embodiment can be simultaneously mixed, optionally with one or more additives. The mixture can be melt-extruded and prepared into pellets.

According to another embodiment, a molded product fabricated using the thermoplastic resin composition is provided. The thermoplastic resin composition can be used to manufacture a molded product using any various known processes such as injection molding, blow molding, extrusion molding, thermal molding, and the like. For example, the thermoplastic resin composition may be used to make various electronic parts, automobile parts, miscellaneous parts, and the like that require excellent scratch resistance, surface slip properties, abrasion resistance, high gloss, impact resistance, heat resistance, workability, coloring properties, and the like.

The following examples illustrate this invention in more detail. However, it is understood that this invention is not limited by these examples.

A thermoplastic resin composition according to one embodiment includes each component as follows.

(A) Core-Shell Structured Copolymer

Methyl methacrylate-acrylonitrile-butadiene-styrene (MABS) powder having a moisture content of less than or equal to 1% is obtained by adding an emulsifier, a polymerization initiator, and a molecular weight controlling agent to 55 wt % of polybutadiene rubber having an average particle diameter of 200 nm, 33.2 wt % of methyl methacrylate, 2.3 wt % of acrylonitrile, and 9.5 wt % of styrene and performing an emulsification graft, and solidifying, dehydrating, and drying the resultant polymer.

(B) Acrylic-Based Polymer

(B-1) A methylmethacrylate-styrene-acrylonitrile (MSAN) copolymer having a weight average molecular weight of 100,000 g/mol is prepared by adding 73.9 wt % of methylmethacrylate, 5 wt % of acrylonitrile, and 21.1 wt % of styrene, adding a polymerization initiator, an organic dispersing agent, a dispersion adjuvant, a molecular weight controlling agent, and deionized water and performing a suspension polymerization, and thereafter dehydrating and drying the resultant polymer.

(B-2) IF850 of LG MMA Corporation is used as a polymethylmethacrylate (PMMA) having a weight average molecular weight of 80,000 g/mol.

(C) Surface-Controlling Agent

(C-1) FINAWAX-S (stearamide), (C-2) FINAWAX-ER (erucamide), (C-3) FINAWAX-OK (oleamide), and (C-4) FINAWAX-BR (behenamide) of FINE ORGANICS Corporation are used as a fatty acid amide compound.

(C′) Lubricant

Unister H-476 of N.O.F Corporation is used as a fatty acid-based ester lubricant.

### EXAMPLES 1 TO 9 AND COMPARATIVE EXAMPLES 1 to 3

The thermoplastic resin compositions according to Examples 1 to 9 and Comparative Examples 1 to 3 are prepared using the components described above the following Table 1 according to the amounts described in Table 1. As for the manufacturing method, the components are mixed in the amounts of the following Table 1 and extruded in a twin-screw extruder at a temperature range of 180 to 280° C. to produce a pellet-type extrudate.

Specimens are prepared by drying the produced pellets at 80° C. for 2 hours, and injecting the pellets using an injection molding machine having an injection capacity of 6 oz under the conditions of a molding temperature of 180 to 280° C. and a molding temperature of 40 to 80° C. The properties of the prepared specimens are measured in accordance with the following methods and the measurement results are shown in the following Table 1.

(1) IZOD Impact strength: measured in accordance with ASTM D256 (specimen thickness ⅛″).

(2) Fluidity: fluidities of 10-kg specimens are measured at 220° C. in accordance with ISO1103.

(3) Coloring properties: A dL value is measured with a colorimeter. Herein, if the dL value is in a negative direction, chroma is increased to have excellent coloring properties. Also, the specimens are observed with the naked eye as well. *Naked eye scale: ⊚-very good, ∘-good, Δ-average, X-bad (4) R-hardness: R-hardness is measured in accordance with ASTM D785.

(5) Abrasion resistance: Abrasion resistance is evaluated with 1-axis abrasion resistance test equipment. Whether the surface of the specimen is scratched or not is measured by attaching microfiber cloth to the axis, and rubbing the microfiber cloth on the specimen with a shuttle range of 5 cm 60 times per minute. The number of times needed to produce a scratch is measured and evaluated.

(6) Width of BSP (Ball type Scratch Profile): Loads of 300 g, 500 g and 1000 g are applied to the specimens and the specimens are scratched at a speed of 75 mm/min using a tungsten carbide stylus having a spherical tip with a diameter of 0.7 mm based on a Cheil method. The roughness of the surfaces of the specimens is observed and the scratch widths are measured with a surface profiler.

TABLE 1

| | | | | | | | | | | | Comparative | | |
|---|---|---|---|---|---|---|---|---|---|---|---|---|---|
| | | Examples | | | | | | | | | Examples | | |
| | | 1 | 2 | 3 | 4 | 5 | 6 | 7 | 8 | 9 | 1 | 2 | 3 |
| (A) Core-shell strucured | | 13 | 13 | 13 | 13 | 13 | 13 | 13 | 13 | 13 | 13 | 13 | 13 |
| copolymer (wt %) | | | | | | | | | | | | | |
| (B) Acryl-based | (B-1) | 77 | 77 | 77 | 77 | 77 | 77 | 77 | 77 | 87 | 77 | 77 | 77 |
| polymer | MSAN(wt %) | | | | | | | | | | | | |
| | (B-2) | 10 | 10 | 10 | 10 | 10 | 10 | 10 | 10 | | 10 | 10 | 10 |
| | PMMA(wt %) | | | | | | | | | | | | |
| (C) | (C-1) (parts by | 0.5 | 1.0 | 1.5 | 2.0 | 3.0 | — | — | — | 1.0 | — | 7.0 | — |
| Surface-controlling | weight *) | | | | | | | | | | | | |
| agent | (C-2) (parts by | — | — | — | — | — | 1.0 | — | — | — | — | | — |
| | weight *) | | | | | | | | | | | | |
| | (C-3) (parts by | — | — | — | — | — | — | 1.0 | — | — | — | | — |
| | weight *) | | | | | | | | | | | | |
| | (C-4) (parts by | — | — | — | — | — | — | — | 1.0 | — | — | | — |
| | weight *) | | | | | | | | | | | | |

| (C′) Lubricant (parts by weight *) | | — | — | — | — | — | — | — | — | — | — | — | 1.0 |
|---|---|---|---|---|---|---|---|---|---|---|---|---|---|
| IZOD impact strengh | | 3.0 | 3.3 | 3.1 | 2.9 | 2.9 | 3.0 | 2.9 | 3.3 | 3.2 | 2.9 | 2.0 | 3.0 |
| (kgf · cm/cm) | | | | | | | | | | | | | |
| Fluidity (g/10 min) | | 26.5 | 33.5 | 36.3 | 37.2 | 38.1 | 32.8 | 30.8 | 31.6 | 28.1 | 24.0 | 40.5 | 26.3 |
| Coloring properties | Naked eye | ⊚ | ⊚ | ⊚ | ⊚ | ◯ | ⊚ | ⊚ | ⊚ | ⊚ | ⊚ | Δ | ◯ |
| | dL | −0.03 | −0.01 | −0.02 | +0.03 | +0.08 | −0.01 | −0.02 | −0.01 | −0.01 | — | +0.18 | +0.10 |

| R-hardness | | 116.8 | 116.3 | 116.1 | 116.0 | 116.3 | 116.3 | 116.5 | 116.5 | 116.5 | 117.1 | 115.4 | 116.1 |
|---|---|---|---|---|---|---|---|---|---|---|---|---|---|
| Abrasion resistance | | 500 | 1000 | 1300 | 1300 | 1300 | 1200 | 1200 | 1000 | 800 | 300 | 1200 | 300 |
| | | times | times | times | times | times | times | times | times | times | times | times | times |
| BSP width (μm) | 1000 g | 256 | 255 | 254 | 252 | 253 | 260 | 258 | 260 | 265 | 262 | 260 | 259 |
| | 500 g | 208 | 200 | 198 | 195 | 195 | 210 | 206 | 204 | 215 | 216 | 196 | 208 |
| | 300 g | 174 | 168 | 164 | 163 | 163 | 178 | 180 | 181 | 190 | 188 | 162 | 187 |

* Parts by weight: a unit representing an amount based on the total weight of the core-shell structured copolymer (A) and the acrylic-based polymer (B) as 100 parts by weight.

Examples 1 to 9 including all of the core-shell structured copolymer, acrylic-based polymer and surface-controlling agent in accordance with one embodiment have excellent scratch resistance, surface slip properties, abrasion resistance, impact resistance, workability, high gloss, coloring properties, and hardness characteristics, as compared with Comparative Example 1 that did not use a surface-controlling agent, Comparative Example 2 that used the surface-controlling agent in an amount outside of the range of one embodiment, and Comparative Example 3 that used a lubricant instead of a surface-controlling agent.

Examples 1 to 9 using a variety of different fatty acid amide compounds as a surface-controlling agent all have improved abrasion resistance.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A thermoplastic resin composition, comprising:
(A) about 10 to about 40 wt % of a core-shell structured copolymer including a shell polymerized from at least an acrylic-based compound;
(B) about 60 to about 90 wt % of an acrylic-based polymer polymerized from at least an acrylic-based monomer; and
(C) about 0.1 to about 5 parts by weight of a surface-controlling agent based on about 100 parts by weight of (A) and (B).

2. The thermoplastic resin composition of claim 1, wherein the shell is polymerized from the acrylic-based compound and a copolymer of an aromatic vinyl compound and a vinyl cyanide compound.

3. The thermoplastic resin composition of claim 2, wherein the shell is polymerized from about 50 to about 80 wt % of the acrylic-based compound and about 20 to about 50 wt % of the copolymer of an aromatic vinyl compound and a vinyl cyanide compound.

4. The thermoplastic resin composition of claim 1, wherein the core-shell structured copolymer (A) comprises a copolymer in which the acrylic-based compound and a copolymer of an aromatic vinyl compound and a vinyl cyanide compound are grafted on a polybutadiene rubber.

5. The thermoplastic resin composition of claim 1, wherein the acrylic-based polymer (B) is polymerized from about 40 wt % or more of the acrylic-based monomer, based on the total amount of the acrylic-based polymer.

6. The thermoplastic resin composition of claim 1, wherein the acrylic-based polymer (B) is polyalkyl(meth)acrylate; a copolymer of an acrylic-based monomer and an aromatic vinyl monomer; a copolymer of an acrylic-based monomer, an aromatic vinyl monomer, and a vinyl cyanide monomer; or a combination thereof.

7. The thermoplastic resin composition of claim 1, wherein the surface-controlling agent (C) comprises a fatty acid amide compound.

8. The thermoplastic resin composition of claim 1, wherein the surface-controlling agent (C) comprises stearamide, erucamide, oleamide, behenamide, or a combination thereof.

9. The thermoplastic resin composition of claim 1, wherein the thermoplastic resin composition comprises an additive including an antibacterial agent, a heat stabilizer, an antioxidant, a release agent, a light stabilizer, a surfactant, a coupling agent, a plasticizer, an admixture, a colorant, a stabilizer, a lubricant, an antistatic agent, a coloring aid, a flameproofing agent, a weather-resistance agent, an ultraviolet (UV) absorber, an ultraviolet (UV) blocking agent, a nucleating agent, an adhesion aid, an adhesive, or a combination thereof.

10. A molded product fabricated using the thermoplastic resin composition of claim 1.
